(19) United States
(12) Patent Application Publication
(10) Pub. No.: US 2007/0040869 A1
(43) Pub. Date: Feb. 22, 2007

(54) Print head for large scale printing apparatus

(76) Inventor: William M. Barton JR., Encinitas, CA (US)

Correspondence Address: HAYNES AND BOONE, LLP, 901 MAIN STREET, SUITE 3100, DALLAS, TX, 75202, US

(21) Appl. No.: 11/208,361

(22) Filed: Aug. 19, 2005

(51) Int. Cl. B41J 2/045

(52) U.S. Cl. 347/68

(57) ABSTRACT

An injection molded print head for an assembly of print heads for large scale printing of, e.g., billboards, banners, posters and the like, includes a nozzle plate that is bonded to a manifold plate. The manifold plate is formed with ink-receiving nozzle chambers that are coaxially registered with respective nozzles in the nozzle plate. The bonded manifold and nozzle plates may be removed from the balance of the print head for nozzle cleaning/replacement purposes. A transducer holder supports piezoelectric transducers that are coaxially registered with respective nozzle chambers. A pulse transmitting plate is disposed between the transducer holder and the manifold plate for transmitting energy from the transducers to the nozzle chambers to thereby controllably discharge ink through selected nozzles. The nozzles may be arranged in columns, with each column being canted at an oblique angle relative to the direction of print head movement over the substrate to be printed.

### BACKGROUND OF THE INVENTION

The present invention generally relates to liquid dispensing apparatus and, in representatively illustrated embodiments thereof, more particularly provides piezoelectric print head apparatus and associated methods for use in conjunction with large scale print systems such as those utilized for billboards, banners, posters and the like.

Large substrates for supporting images used in billboards, banners, posters and the like can be printed with printing machines that incorporate therein a number of individual print heads. Most printing machines of this type move their associated print heads across the substrate and deposit ink from the print heads onto the substrate. To enable the many individual print heads to precisely form the intended image on the substrate the print heads are typically controlled by a suitable printing computer electronically linked to corresponding electrical circuitry in the print heads.

Conventionally constructed print heads, such as piezoelectric print heads, used in this type of large scale printing apparatus are subject to a variety of well known problems, limitations and disadvantages. For example, due to the very high degree of constructional precision and ink deposition accuracy required of the typical print head, which discharges ink through selectively variable ones of a very closely spaced array of tiny discharge nozzles or orifices, they have typically been fabricated using precision microfabrication technology in which various ink handling portions of a given print head are produced using multi-step precision clean room operations. The use of this very high cost clean room technology undesirably increases the final cost of the print heads, and thus the overall printing machine in which they are operatively incorporated.

Not only does the fabricational cost of various portions of a typical print head tend to be quite high, but a great degree of precision is normally required to correctly assemble these high cost components into a finished print head having the high requisite degree of ink deposition accuracy. As a result, it is often difficult to maintain a desired level of repeatability in assemblage precision from print head to print head.

Because of the conventional necessity of fabricating various intricate print head components such as shared wall piezoelectric ink chambers, it has been difficult to construct print heads which have a desirable degree of ruggedness. Due to a combination of their intricacy and requisite precision construction techniques they tend to be undesirably delicate and easily damaged if not handled quite carefully.

As is well known in the printing arts, the leading cause of failure of conventional print heads is the clogging of their tiny ink jet discharge nozzles or orifices. Once this nozzle clogging occurs (typically due to particulate contaminants present in the ink or drying of the ink on the nozzle), the print head's operational life is effectively at an end since the nozzle portion of the print head, using conventional print head construction techniques, is permanently affixed to the balance of the print head. This substantially limits cleaning or replacement of the clogged ink discharge nozzle section of the print head except by specially trained technicians.

The various ink discharge nozzles in a conventional print head are typically formed in a nozzle discharge plate structure which is fixedly secured to the balance of the print head. To provide the nozzle spacing and dimensional accuracy required, it is customary to form the nozzles with a laser prior to securement of the resulting apertured nozzle plate to the balance of the print head in a manner precisely aligning the laser-formed nozzles with associated ink holding chambers in the print head body portion to which the nozzle plate is fixedly secured. The need to do this stems from the necessity of causing the laser to pass through the nozzle plate in the same direction that ink will be forced outwardly through the resulting ink discharge nozzles. Because of this conventional construction technique it is often difficult to correctly align the series of ink discharge nozzles with their associated series of ink holding chambers.

In one conventional form of an ink dispensing print head the portion thereof in which the ink holding chambers are disposed is formed from a piezoelectric material which rapidly deforms, and then returns to its original configuration, in response to a very short duration pulse of electrical current flowed therethrough and then terminated. To discharge ink from a given discharge nozzle, wall portions of its associated ink holding chamber are piezoelectrically deflected inwardly and then relaxed to trigger the ejection of a small quantity of ink outwardly through the nozzle onto an adjacent substrate. Because each ink holding chamber is not only an ink reservoir, but also an ink driving structure, no two immediately adjacent ink discharge nozzles whose ink chambers share a common deflectable driving wall may be simultaneously “fired” to discharge ink therefrom.

As may be readily seen from the foregoing, a need exists for improved print head or other liquid dispensing apparatus and associated methods which eliminate or at least substantially reduce the above-mentioned problems, limitations and disadvantages typically associated with conventional print head apparatus and associated methods as generally described above. It is to this need that the present invention is primarily directed.

### SUMMARY OF THE INVENTION

In carrying out principles of the present invention, in accordance with representative embodiments thereof, this invention provides specially designed liquid dispensing apparatus and associated methods which are incorporated in an ink jet print head utilized in large scale printing operations such as printing on billboards, banners, posters and carried with other similar print heads for movement along a substrate to be printed upon.

In a preferred structural arrangement thereof, the print head comprises a nozzle plate formed with plural ink nozzles which representatively face downwardly but could alternatively face upwardly if desired, and a manifold plate engaged with the nozzle plate and formed with plural ink nozzle chambers. A transducer holder mounted over the manifold plate supports plural piezoelectric transducers, each transducer being registered with a respective nozzle chamber which, in turn, is registered with one of the nozzles. A pulse transmitting plate is disposed between the transducer holder and the manifold plate and is used, in response to deflection of the transducers, to transmit energy, in the form of shock waves, from the transducers to the nozzle chambers to force ink outwardly therefrom via their associated nozzles.

The chambers in the manifold plate serve merely to store the ink forced outwardly through their associated nozzles—their walls are not made of piezoelectric material which must be electrically deflected to force ink out of such nozzles and to laterally confine the ink-driving shock wave passing axially therethrough. This permits both the manifold plate and the transducer holder to be formed as inexpensive injection moldings to thereby provide the print head with a substantial degree of cost reduction and increased ruggedness compared to conventional piezoelectric print heads which depend on piezoelectric ink chamber wall deflection for creating operative ink discharge therefrom.

The injection molded construction of the print head in its preferred form also substantially simplifies the construction and assembly thereof while maintaining the requisite degree of component-to-component alignment accuracy necessary to obtain the critical precision in the printing process. Further, this unique construction of the print head permits any two immediately adjacent nozzles to be “fired” (i.e., have ink discharged therefrom) simultaneously since their associated ink chamber walls do not have to be piezoelectrically defected to effect ink discharge therefrom.

The pulse transmitting plate is disposed externally to the ink chambers. When it is desired to discharge ink from one of the nozzles, the pulsed piezoelectric transducer is electrically deflected to in turn exert a force against a portion of the plate overlying the ink chamber communicating with the nozzle to be fired. This plate-received force creates a shock wave which is transmitted through the selected chamber to discharge ink from its nozzle.

According to another aspect of the invention, a spaced apart series of pulse-dissipating spacer structures are interposed between the manifold plate and the pulse transmitting plate and serve to create between such spacer structures pulse dissipation passages that helps to prevent energy from the created pulse from entering adjacent ink chambers, or at least substantially lessen the pulse energy entering adjacent chambers and undesirably discharging ink therefrom. Such pulse energy dissipation may also be achieved by the formation of a spaced series pulse dissipation cavities on the pulse transmitting plate side of the manifold plate. In an alternate embodiment of the pulse transmitting plate, the plate has lateral projections which are received within inlet end portions of the ink chambers. Accordingly, when a particular portion of the pulse transmitting plate is deflected by its associated piezoelectric member, the resulting pulse energy is transmitted via the deflected plate projection directly into the associated chamber, thereby in effect directing or focusing the pulse energy into the intended ink chamber.

In accordance with another feature of the invention, the problem of clogging of the nozzles and the chambers in the manifold plate, which is normally the leading cause of print head failure, is uniquely addressed by attaching the nozzle assembly (i.e., the manifold plate and the nozzle plate secured thereto) to the balance of the print head in a manner permitting it to be easily manually removed to permit cleaning of the nozzles and associated ink chambers and replacement of the cleaned nozzle assembly. Alternatively, the removed nozzle assembly may be replaced with another nozzle assembly—either an identical or different nozzle assembly—very quickly, easily and accurately. Representatively, the nozzle assembly is removably and sealingly clamped to the balance of the print head.

According to a further aspect of the invention, the nozzles in the nozzle plate are arranged thereon in plural columns each defining a nozzle line being canted at an oblique angle, representatively about three degrees, relative to the linear direction of operational movement of the print head. This provides the print head with a greater print resolution, in a direction transverse to such linear direction of operational movement, on the associate substrate to be printed.

In yet another aspect of the invention the constructional accuracy of the print head is increased by securing the nozzle plate to a side of the manifold plate before the ink discharge nozzles are formed in the nozzle plate. Laser beams directed through the chambers in the manifold plate and onto the attached nozzle plate to form the ink discharge nozzles therein. In this manner the nozzles may be accurately aligned with their associated ink chambers without having to align previously formed nozzles with such chambers after the nozzles are formed in the nozzle plate.

Representatively, other features are included in the print head including heating apparatus for selectively heating the manifold plate, filter apparatus for filtering liquid supplied to the nozzle chambers, and air removal apparatus for removing air from an interior portion of the print head communicating with the nozzle chambers.

Principles of the present invention are not limited to print heads, but are also applicable to other types of liquid dispensing apparatus used to meter and/or deposit liquids other than ink. Principles of the invention are similarly not limited to large scale liquid dispensing operations, but are also applicable to smaller scale applications such as in smaller scale print heads, for example those used in personal computer printers.

### BRIEF DESCRIPTION OF THE DRAWINGS

FIG. 1 is a schematic perspective view of a large scale print head assembly embodying principles of the present invention and disposed over a substrate to be printed;

FIG. 2 is an enlarged scale bottom (nozzle) side perspective view of an individual print head removed from the FIG. 1 print head assembly;

FIG. 3 is a partially exploded perspective view of the print head;

FIG. 4 is an exploded top side perspective view of the print head;

FIG. 4A is an enlarged scale top side detail perspective view of a portion of a manifold plate section of the print head;

FIG. 5 is a horizontally directed cross-sectional view through the fully assembled print head, with some of the piezoelectric transducer portions thereof having been removed for purposes of illustrative clarity; and

FIG. 6 is a cross-sectional view through an alternate embodiment of the print head.

### DETAILED DESCRIPTION

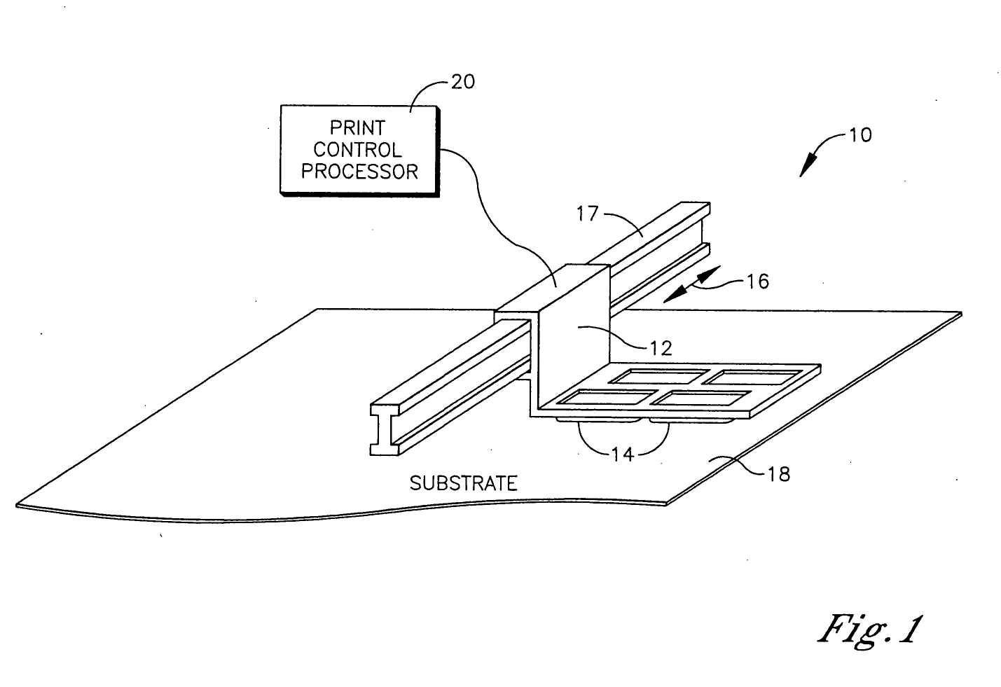

Referring initially to FIG. 1, a system is shown, generally designated 10, which includes a print machine 12 bearing plural print heads 14 according to the present invention. The machine 12 with print heads 14 can be moved in the directions indicated by the arrows 16 (along, e.g., a rail 17) to deposit ink by ink jet printing methods onto a substrate 18, under the control of a processor 20. The substrate 18 may be relatively large, e.g., several feet by several feet, for covering a billboard, banner, poster of the like. While only two print heads 14 are shown, it is to be understood that the print machine 12 may have any number of heads, e.g., four, sixteen, or any other appropriate number.

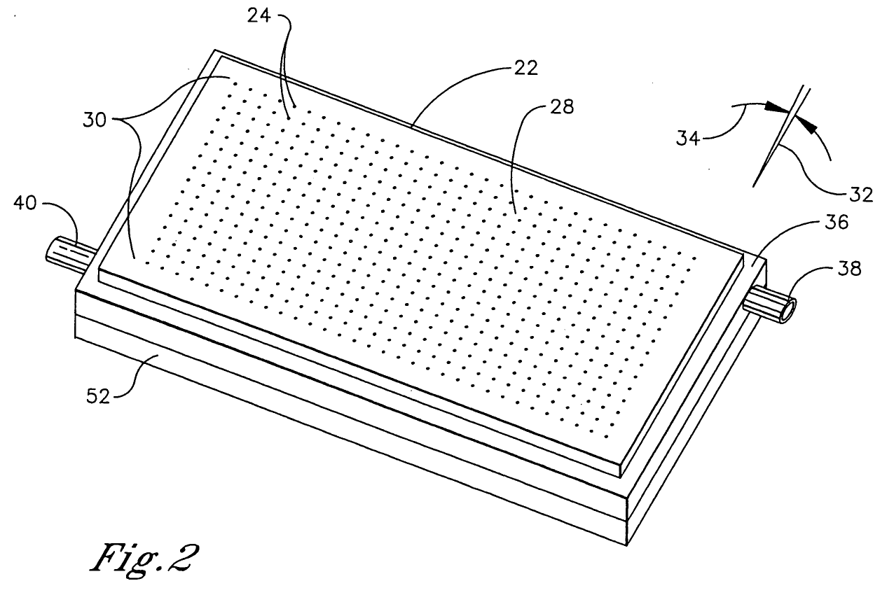

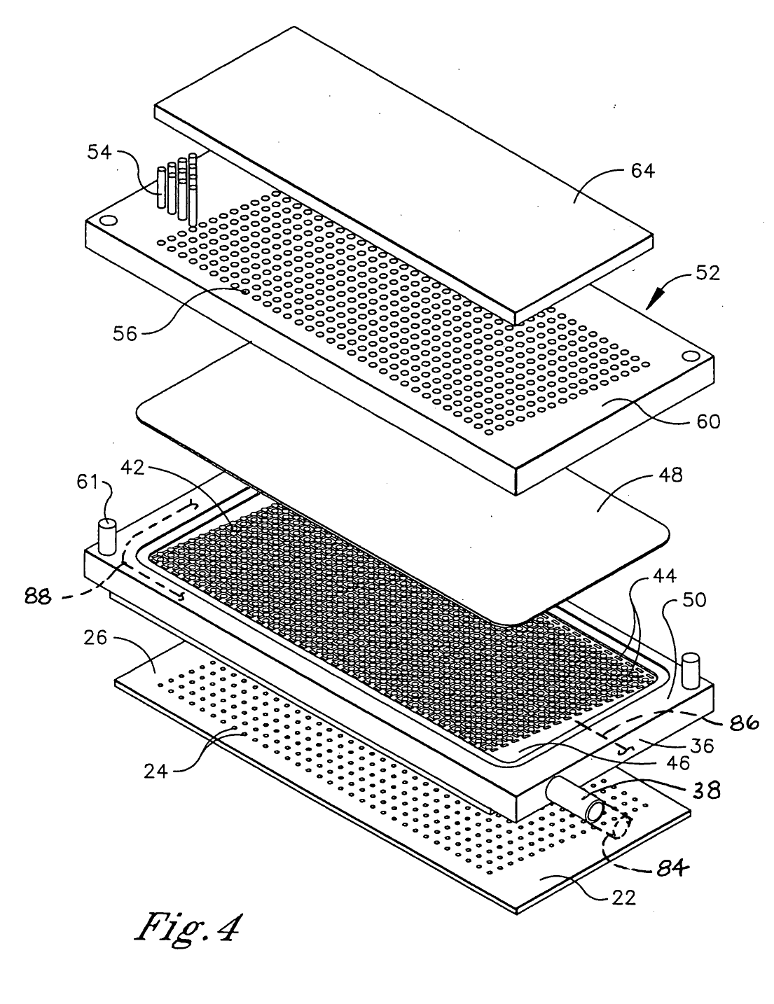

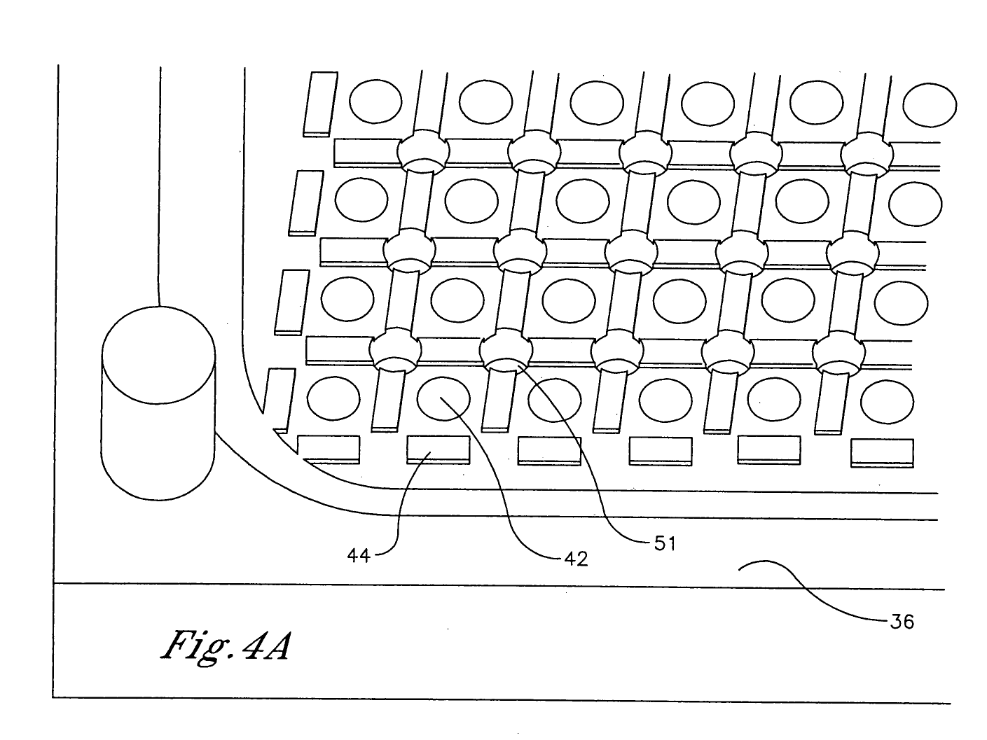

Now referring to FIGS. 2-5, a first embodiment of the present print head can be seen. The print head includes a nozzle plate 22 that is formed with plural ink nozzles 24, with each nozzle having a very small diameter, e.g., fifty microns. The nozzle plate 22 may be made of a polymer or metal material. in one embodiment the nozzle plate 22 is a flat parallelepiped-shaped plate having an entrance surface 26 (FIG. 4) and an exit surface 28 (FIG. 2), the nozzles 24 extending from surface to surface. Ink is deposited onto the substrate shown in FIG. 1 through the nozzles 24.

In the embodiment shown in FIGS. 2-5, the nozzles 24 are arranged in co-parallel linear columns 30. In non-limiting embodiments each column 30 may have sixteen nozzles 24, and the nozzle plate 22 may be formed with thirty two columns 30. The print head may move over the substrate along the illustrated operational movement line 32, and each column 30 may be canted with respect to the line 32 of motion by an oblique angle 34. In one embodiment the angle 34 is an acute angle of about three degrees or so. In this way, as the print head moves across the substrate a nozzle does not follow the exact path as the nozzle in front or behind, but rather a path that is offset by a small amount from the paths of the other nozzles. As understood herein, relatively powerful print control processors have sufficient processing power to account for the offset and use it advantageously.

As shown, the entrance surface 26 of the nozzle plate 22 may be adhesively bonded to a surface of an injection molded, generally parallelepiped-shaped manifold plate 36, the bonded-together nozzle plate and manifold plate forming the previously mentioned nozzle assembly. As shown in FIG. 2, the manifold plate 36 may be formed with an ink inlet conduit 38 and an ink outlet conduit 40, between which ink can pass and flow into the cavities described further below.

Specifically and referring to FIGS. 4 and 4A, the manifold plate 36 is formed with plural nozzle chambers 42 that extend all the way through the manifold plate 36, with each nozzle 24 in the nozzle plate 22 being registered with a respective nozzle chamber 42. The nozzle chambers 42 may be cylindrical as shown and preferably are coaxial with their respective nozzles 24. Each nozzle chamber 42 may have a diameter of a millimeter or a bit larger. Ink from the inlet 38 can flow into the nozzle chambers 42.

In some implementations and as best shown in FIGS. 4 and 4A, spacers 44 may be formed integrally on the manifold plate 36 and may be juxtaposed with the nozzle chambers 42. In less preferred implementations the spacers may be made separately from the manifold plate and adhered thereto. In the preferred implementation shown, substantially all nozzle chambers 42 are straddled by at least two opposed spacers 44, it being understood that alternatively, the spacers may be formed on the pulse transmitting plate.

As shown, the spacers 44 may be parallelepiped-shaped and may extend slightly above the surface 46 into which the nozzle chambers 42 are formed. A barrier structure, representatively a flat pulse transmitting plate 48, one side of which may be copper, rests on the spacers 44 within a support flange 50 that is formed on the manifold plate 36 and that rises above and circumscribes the surface 46. The spacers 44 thus slightly space the pulse transmitting plate 48 from the nozzle chambers 42 in the manifold plate 36, as well as attenuate pulses intended to be directed into a nozzle chamber 42 from propagating to nearby nozzle chambers.

Additionally, if desired for further pulse energy attenuation laterally outwardly of a nozzle chamber being fired, attenuation cavities 51 may be formed on the manifold plate 36 at what would be the intersection of adjacent spacers 44, i.e., diagonally relative to the nozzle chambers 42. Each attenuation cavity 51 may be about a millimeter or so in diameter and about a millimeter or so in depth, or have other suitable dimensions as needed to absorb shock wave energy before it is transmitted to an adjacent ink chamber.

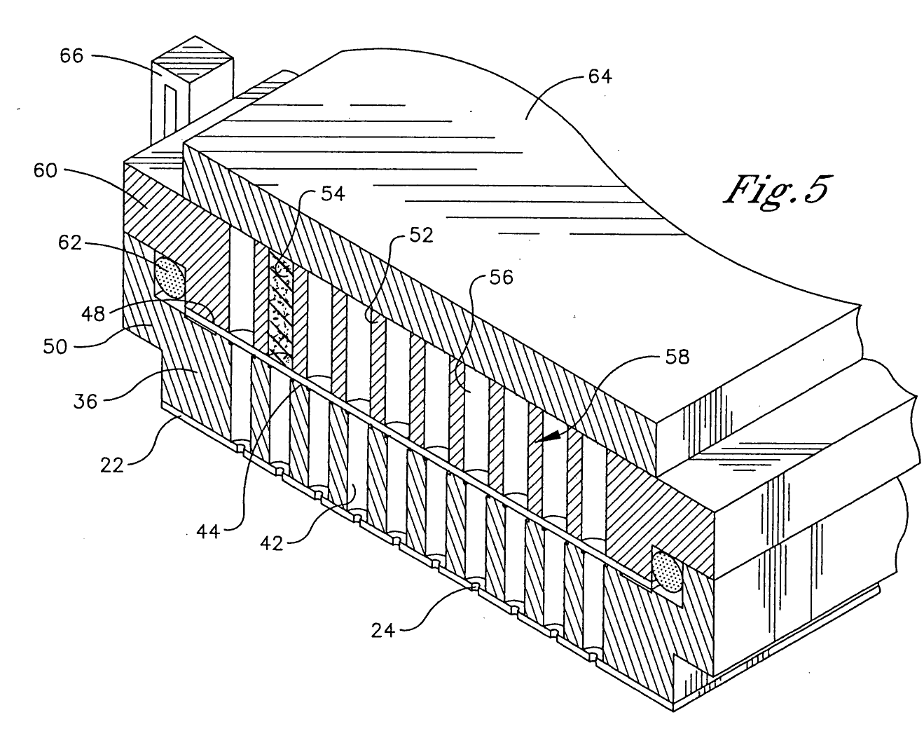

Returning to FIG. 4 and as also shown in FIG. 5, an injection molded transducer holder 52 is disposed on the manifold plate 36 with the pulse transmitting plate 48 sandwiched therebetween. As shown best in FIGS. 4 and 5, the transducer holder 52 supports plural preferably piezoelectric transducers 54, and each transducer 54 touches the pulse transmitting plate 48 and is registered with a respective nozzle chamber 42 of the manifold plate 36 and, hence, with a respective nozzle 24 in the nozzle plate 22. Thus, a nozzle chamber 42 may be coaxial not only with its respective nozzle 24 but also with its respective transducer 54. Like the nozzle chambers 42, the transducers 54, which may be made entirely of piezoelectric material or only partially of piezoelectric material, may be cylindrical, or have another suitable shape such as a rectangular shape.

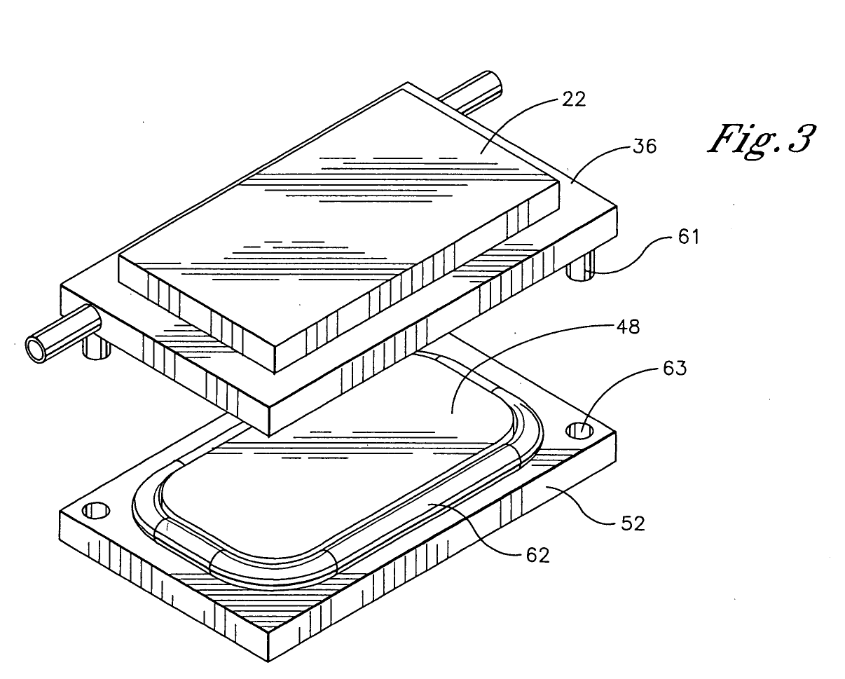

With respect to the illustrative non-limiting structure of the transducer holder 52 shown, each transducer 54 may be disposed in a respective transducer cavity 56 that is formed during injection molding in a holder section 58 of the transducer holder 52. FIG. 5 best shows that, recessed away from the surface of the holder section 58 that contacts the pulse transmitting plate 48 and circumscribing the holder section 58, is a flange section 60. The flange section 60 of the transducer holder 52 rests against the support flange 50 of the manifold plate 36. A seal such as a resilient racetrack-shaped o-ring 62 (FIGS. 3 and 5) is disposed in slight compression between the transducer holder 52 and manifold plate 36 just inboard of the support flange 50/flange section 60 and, hence, surrounding the pulse transmitting plate 48. To help engage the manifold plate 36 with the transducer holder 52 in proper registration, one or more locating pins 61 may be formed on the manifold plate 36 and may be closely received into respective pin channels 63 formed in the holder 52.

Still referring to FIGS. 4 and 5, a printed circuit board (PCB) 64 rests on top of the transducer holder 52 in electrical communication with each transducer 54. The PCB 64 may be controlled by the processor 20 shown in FIG. 1. With the above structure in mind, signals from the PCB 64 may be generated to axially deform transducers 54 as selected by the processor 20. When a transducer 54 deforms, a deflection is created on the pulse transmitting plate 48, which relays the pulse, in the form of a shock wave, to the respective nozzle chamber 42 that is registered with the transducer 54. The spacers 44 serve to confine the pulse to the intended nozzle chamber 42. In turn, ink is caused to exit the nozzle 24 that is registered with the nozzle chamber 42 to thereby deposit ink onto the substrate 18.

Advantageously, the nozzle assembly that is established in the non-limiting embodiment shown by the nozzle plate 22 and manifold plate 36 can be easily manually disengaged from the remaining print head structure for cleaning. Stated differently, the manifold plate 36 may be removably engaged with the transducer holder 52 so that a person can easily disengage the manifold plate 36 (with nozzle plate 22) from the transducer holder 52 to clean the nozzles and nozzle chambers, and can then easily reengage the same nozzle assembly with the transducer holder 52 after cleaning. Or, a different nozzle assembly possibly having differently sized nozzles that are suitable for a different type of ink may be engaged with the transducer holder 52.

Excluded from the definition of “removably engaged” and “easily manually disengaged” (or “easily manually engaged”) is adhesive bonding, welding of any type, brazing, rf sealing, and riveting. Encompassed within the definition of “removably engaged” and “easily manually disengaged” are threaded fasteners. In a preferred embodiment, however, an engagement member such as one or more clamps 66 (FIG. 5) can be used to clamp the manifold plate 36 (with nozzle plate 22) to the transducer holder 52, such that a person can easily manipulate the clamp 66 without the need for tools to remove the manifold plate 36 from the remainder of the print head structure. The clamp 66 may be a simple metal U-shaped resilient clip that is sized for a snug interference fit around the manifold plate 36/transducer holder 52, or a spring loaded alligator-style clamp, or other convenient clamping mechanism that may be easily manually installed and removed.

The above structure also affords further advantages. For instance, the manifold plate 36 may be formed as shown by injection molding, and the nozzle plate 22 may be a thin polymer or metal but without the nozzles 24 yet formed. Then, the nozzle plate 22 may be adhesively bonded to the manifold plate 36, and a laser directed through the nozzle chambers 42 (typically sequentially) to form the nozzles 24 in the exposed area of the entrance surface 26 of the nozzle plate 22. In this way, the nozzles 24 are automatically registered with their respective nozzle chambers 42, and furthermore the laser beam exits the exit surface 28 of the nozzle plate 22, leaving a structurally clean exit area where it is most needed, i.e., where ink subsequently exits the nozzle during operation. Further, any two immediately adjacent nozzles 24 can be simultaneously fired since it is not necessary to deflect any of the side walls of their associated chambers 42 to do so.

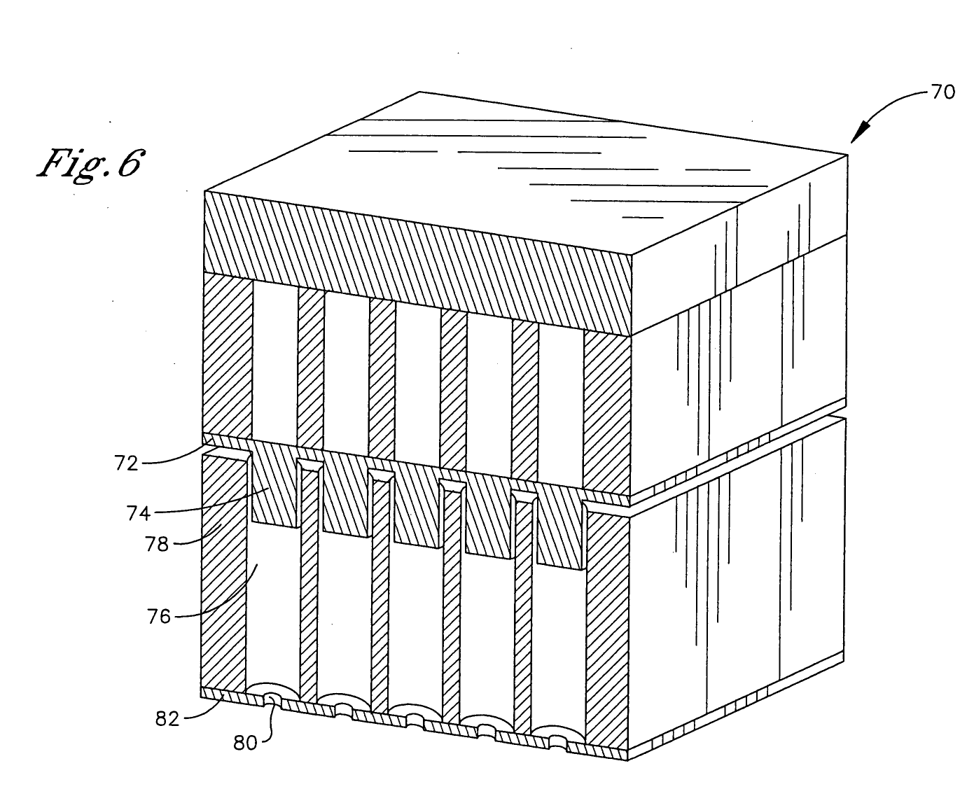

FIG. 6 shows a print head 70 that is in all essential respects identical to the print head shown in FIGS. 2-5, except that a pulse transmitting plate 72 is formed with plural preferably cylindrical rods 74 extending into respective nozzle chambers 76 of a manifold plate 78, to further focus shock wave pulses into the desired nozzle 80 of a nozzle plate 82. The rods 74 may be stiff material, e.g., carbon fiber, and may be projections having non-cylindrical configurations, such as rectangular or other shapes if desired. As representatively illustrated, the bottom ends of the rods 75 are essentially flat. However, the lower rod ends could alternatively have other shapes such as, for example, concave or convex configurations if desired to better focus the shock waves through the ink chambers.

As schematically depicted in phantom in FIG. 4, the print heads illustrated in FIGS. 2-6 may have other desirable structures incorporated therein if desired. For example, a filter 84 may be installed on the print head, representatively on the ink inlet 38, to filter out particulate matter in the incoming ink supply. Further, an air removal tube 86 may be coupled to a suitable source or negative pressure and extended into an interior portion of the print head, which communicates with the nozzle chambers, to remove unwanted air from such interior print head portion. Additionally, a heating structure, such as the illustrated electric heating structure 88 imbedded in the manifold plate 36, may be used to heat the ink as needed to compensate for ink viscosity and/or variations in ambient print head operating temperatures.

While principles of the present invention have been representatively illustrated as being embodied in a print head, the invention is not limited to print head applications, and may be advantageously utilized in a variety of other types of liquid dispensing apparatus used to meter and/or deposit liquids other than ink.

The foregoing detailed description is to be clearly understood as being given by way of illustration and example only, the spirit and scope of the present invention being limited solely by the appended claims.

In such claims, reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. Liquid dispensing apparatus comprising:
a nozzle plate formed with plural liquid nozzles;
a manifold plate engaged with the nozzle plate and formed with plural nozzle chambers, each nozzle being registered with a respective nozzle chamber;
a transducer holder supporting plural transducers, each transducer being registered with a respective nozzle chamber; and
a pulse transmitting plate between the transducer holder and the manifold plate for transmitting energy from the transducers to the nozzle chambers to eject liquid outwardly therefrom via their associated nozzles, the pulse transmitting plate being formed with plural projections extending into respective nozzle chambers of the manifold plate.

2. The liquid dispensing apparatus of claim 1 wherein:
the liquid dispensing apparatus is a print head,
the nozzle chambers are adapted to contain ink, and
the transducers are piezoelectric transducers.

3. The liquid dispensing apparatus of claim 1 wherein:
a nozzle chamber is coaxial with its respective nozzle and transducer.

4. The liquid dispensing apparatus of claim 1 wherein:
the liquid dispensing apparatus further comprises spacers on the manifold plate juxtaposed with the nozzle chambers, and
substantially all nozzle chambers are straddled by at least two opposed spacers, the spacers being disposed on the manifold plate next to the pulse transmitting plate.

5. Liquid dispensing apparatus comprising:
a nozzle plate formed with plural liquid nozzles;
a manifold plate engaged with the nozzle plate and formed with plural nozzle chambers, each nozzle being registered with a respective nozzle chamber;
a transducer holder supporting plural transducers, each transducer being registered with a respective nozzle chamber;
a pulse transmitting plate between the transducer holder and the manifold plate for transmitting energy from the transducers to the nozzle chambers to eject liquid outwardly therefrom via their associated nozzles; and
attenuation cavities formed on the manifold plate and juxtaposed with the nozzle chambers,

6. The liquid dispensing apparatus of claim 1 wherein:
the manifold plate is injection molded.

7. The liquid dispensing apparatus of claim 1 further comprising:
a resilient seal sandwiched between the manifold plate and the transducer holder and surrounding the pulse transmitting plate.

8. The liquid dispensing apparatus of claim 1 wherein:
the liquid dispensing apparatus, during operation thereof, is movable in a linear direction, and the nozzles are arranged on the nozzle plate in plural columns each defining a nozzle line, each nozzle line being canted at an oblique angle relative to the linear direction.

9. The liquid dispensing apparatus of claim 8 wherein:
the angle is approximately three degrees.

10. The liquid dispensing apparatus of claim 1 wherein:
the manifold plate is removably engaged with the transducer holder, whereby a person can easily disengage the manifold with nozzle plate from the transducer holder and can easily engage a manifold plate with the transducer holder.

11. (canceled)

12. The liquid dispensing apparatus of claim 1 wherein:
the liquid dispensing apparatus is an ink jet print head and is operatively supported on a print head assembly holding at least one other similar ink jet print head.

13. The liquid dispensing apparatus of claim 1 further comprising:
heating apparatus for selectively heating the manifold plate.

14. The liquid dispensing apparatus of claim 1 further comprising:
filter apparatus for filtering liquid supplied to the nozzle chamber.

15. The liquid dispensing apparatus of claim 1 further comprising:
air removal apparatus for removing air from an interior portion of the liquid dispensing apparatus communicating with the nozzle chambers.

16. A method of making a liquid dispensing device comprising the steps of:
injection molding a manifold plate with plural nozzle chambers, each nozzle chamber extending from a first surface of the plate to a second surface of the plate;
disposing an entrance surface of a nozzle plate on the second surface of the manifold plate;
orienting the first surface of the manifold plate toward a laser; and
directing a laser beam from the laser through at least one nozzle chamber to form a respective nozzle through the nozzle plate from the entrance surface to an exit surface, whereby the nozzle is registered with a respective nozzle chamber.

17. The method of claim 16 further comprising the step of:
removably attaching the manifold plate to a piezoelectric transducer holder.

18. The method of claim 17 wherein:
the removably attaching step is performed by removably clamping the manifold plate to a piezoelectric transducer holder.

19. The method of claim 17 further comprising the step of:
manually disengaging the manifold plate with nozzle plate from the transducer holder and cleaning the manifold plate with nozzle plate.

20. The method of claim 19 further comprising the step of:
manually reengaging the manifold plate or another manifold plate with the transducer holder.

21-24. (canceled)

25. A print head with a nozzle assembly that can be easily manually disengaged from print head structure for cleaning.

26. The print head of claim 25, wherein the print head structure includes at least a piezoelectric transducer holder.

27. The print head of claim 26, wherein the nozzle assembly includes a nozzle plate and a manifold plate.

28. The print head of claim 27, wherein the manifold plate is formed with plural nozzle chambers and the nozzle plate is formed with plural nozzles, each nozzle being registered with a respective nozzle chamber.

29. The print head of claim 28, wherein the transducer holder supports plural piezoelectric transducers, and each transducer is registered with a respective nozzle chamber.

30. The print head of claim 29, further comprising a pulse transmitting plate between the transducer holder and the manifold plate for transmitting energy from the transducers to the nozzle chambers.

31. The print head of claim 30, wherein a nozzle chamber is coaxial with its respective nozzle and transducer.

32. The print head of claim 30, comprising spacers on the manifold plate juxtaposed with the nozzle chambers, substantially all nozzle chambers being straddled by at least two opposed spacers, the spacers being disposed on the manifold plate next to the pulse transmitting plate.

33. The print head of claim 30, wherein the manifold plate is injection molded.

34. The print head of claim 30, further comprising a resilient seal sandwiched between the manifold plate and the transducer holder and surrounding the pulse transmitting plate.

35. The print head of claim 30, wherein the print head is movable in a linear path relative to a substrate to be printed, and the nozzles are arranged in plural columns each defining a nozzle line, each nozzle line being canted at an oblique angle relative to the linear path.

36. The print head of claim 30, wherein the manifold plate is removably engaged with the transducer holder, whereby a person can easily disengage the manifold plate with nozzle plate from the transducer holder and can easily engage a manifold plate with the transducer holder.

37. The print head of claim 30, wherein the pulse transmitting plate is formed with plural rods extending into respective nozzle chambers of the manifold plate.

38. The print head of claim 30, in combination with a print head assembly holding plural print heads.

39. The print head of claim 25, wherein the nozzle assembly can be detached from the print head structure without tools.

40. Liquid dispensing apparatus comprising:
a wall structure having a nozzle chamber disposed therein and adapted to hold a quantity of liquid, the nozzle chamber communicating with a nozzle opening outwardly through the wall structure, the nozzle chamber having an open end spaced apart from the nozzle along an axis;
a barrier structure supported outwardly adjacent the open end of the nozzle chamber and having an outer side;
a piezoelectric member extending outwardly from the outer side along the axis;
a control system selectively operable to axially distort the piezoelectric member against the barrier structure in a manner causing it to generate a shock wave through the nozzle chamber and responsively cause a discharge of liquid therefrom outwardly through the nozzle; and
an attenuation cavity formed in the wall structure outwardly adjacent the nozzle chamber and operative to attenuate, at a location disposed laterally outwardly of the nozzle chamber, shock wave energy generated by the piezoelectric member.

41. The liquid dispensing apparatus of claim 40 wherein:
the liquid dispensing apparatus is an ink jet print head.

42. The liquid dispensing apparatus of claim 40 wherein:
the barrier structure is spaced apart from the open end of the nozzle chamber by a spacer structure interposed between the barrier structure and the wall structure.

43. (canceled)

44. Liquid dispensing apparatus comprising:
a wall structure having a nozzle chamber disposed therein and adapted to hold a quantity of liquid, the nozzle chamber communicating with a nozzle opening outwardly through the wall structure;
energy transmitting apparatus operative to transmit a shock wave through the nozzle chamber, to thereby discharge liquid outwardly therethrough via the nozzle, without creating a previous appreciable dimensional change in the nozzle chamber said energy transmitting apparatus having a first portion disposed externally of the nozzle chamber, and a second portion projecting into the interior of the nozzle chamber; and
a control system useable to selectively operate the energy transmitting apparatus.

45. The liquid dispensing apparatus of claim 44 wherein:
the liquid dispensing apparatus is an ink jet print head.

46. The liquid dispensing apparatus of claim 44 wherein:
the wall structure is of a non-piezoelectric material.

47. The liquid dispensing apparatus of claim 46 wherein:
the energy transmitting apparatus includes a piezoelectric member.

48. The liquid dispensing apparatus of claim 44 wherein:
the wall structure is of an injection molded construction.

49. A method of operating a liquid dispensing device having first and second immediately adjacent nozzle chambers respectively communicating with first and second liquid discharge nozzles, the method comprising the steps of:
placing liquid in the first and second nozzle chambers; and
piezoelectrically generating energy simultaneously to the first and second nozzle chambers, via structures projecting into the first and second nozzle chambers, to simultaneously discharge liquid from the first and second discharge nozzles without inwardly deflecting any side wall portions of the first and second nozzle chambers.

50. The method of claim 49 wherein:
the liquid dispensing device is an ink jet print head,
the placing step is performed using ink, and
the piezoelectrically generating step creates a simultaneous discharge of ink from the first and second discharge nozzles.

51. Liquid dispensing apparatus comprising:
a wall structure having spaced apart first and second nozzle chambers disposed therein and adapted to hold a quantity of liquid, the first and second nozzle chambers respectively communicating with first and second nozzles opening outwardly through the wall structure;
energy transmitting apparatus operative to transmit a shock wave through a selected one of the first and second nozzle chambers, to thereby discharge liquid outwardly therethrough via its associated nozzle; and
an energy attenuation cavity, formed on the wall structure and juxtaposed with the first and second nozzle chambers, for receiving and attenuating a portion of the shock wave energy created by the energy transmitting apparatus.

52. Liquid dispensing apparatus comprising:
a wall structure having a nozzle chamber disposed therein and adapted to hold a quantity of liquid, the nozzle chamber communicating with a nozzle opening outwardly through the wall structure;
a structure projecting into the nozzle chamber; and
energy transmitting apparatus operable to transmit energy through the structure projecting into the nozzle chamber to create a discharge of liquid outwardly through the nozzle.
